(19) United States
(12) Patent Application Publication
(10) Pub. No.: US 2017/0308571 A1
(43) Pub. Date: Oct. 26, 2017

(54) TECHNIQUES FOR UTILIZING A NATURAL LANGUAGE INTERFACE TO PERFORM DATA ANALYSIS AND RETRIEVAL

(71) Applicant: Google Inc., Mountain View, CA (US)

(72) Inventors: Kevin McCurley, San Jose, CA (US); Qiqi Yan, Mountain View, CA (US); Koen Dirckx, Dublin (IE); Kedar Dhamdhere, Sunnyvale, CA (US); Rifat Ralfi Nahmias, San Francisco, CA (US); Mukund Sundararajan, Sunnyvale, CA (US)

(73) Assignee: Google Inc., Mountain View, CA (US)

(21) Appl. No.: 15/134,010

(22) Filed: Apr. 20, 2016

(51) Int. Cl. G06F 17/30; G06F 17/28

(52) U.S. Cl. CPC G06F 17/30401; G06F 17/30554; G06F 17/28; G06F 17/30398

(57) ABSTRACT

Techniques for utilizing a natural language interface to perform data analysis include receiving a natural language question for retrieving data stored in a database and interpreting the natural language question to generate a structured query for the database. The structured query is translated into a natural language representation of the structured query, which is displayed during execution of the structured query. Responsive data is received and one or more visualization types for presenting the responsive data to the user is determined based on the natural language question, the responsive data, and one or more data types of the data. A visualization of the responsive data is generated based on one visualization type of the determined visualization types, which is displayed in a card in a graphical user interface. The card can include the natural language representation of the structured query and the visualization of the responsive data.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Databases have been and are continuing to be utilized to store vast amounts of data. In order to properly retrieve this data, a user typically must be trained to utilize a specialized query language (Structure Query Language (“SQL”) and the like) to interact with and submit queries to the database. Even users that are trained in such specialized query languages, however, may find it difficult to retrieve useful data if the user is not fully aware of the exact schema of the database. Furthermore, because of the complexity of the design of databases and specialized query languages, typical users that have a need for data stored in a database often must work in conjunction with a trained database “expert” who can design queries, retrieve and process the appropriate data, etc. Such experts, while fully trained on how to retrieve data and utilize the database, likely have no interest in interpreting and utilizing the retrieved data for its intended purpose. Thus, users that have a need of the data stored in a database to perform data analysis may have no knowledge of how to retrieve such data, while users that are specially trained in retrieving data from the database may have no knowledge of what such data represents or the purpose for what such data is intended.

### SUMMARY

In some implementations, a technique for utilizing a natural language interface to perform data analysis and retrieval from a database is disclosed. The technique can include receiving a natural language question for retrieving data stored in the database and interpreting the natural language question to generate a structured query for the database. The structured query can be translated into a natural language representation of the structured query, which can be displayed during execution of the structured query. Responsive data can be received and one or more visualization types for presenting the responsive data to the user can be determined based on the natural language question, the responsive data, and one or more data types of the data. A visualization of the responsive data can be generated based on one visualization type of the determined visualization types, which is displayed in a card in a graphical user interface. The card can include the natural language representation of the structured query and the visualization of the responsive data.

A computing device for utilizing a natural language interface to perform data analysis and retrieval from a database is also described. The computing device can include a display device, one or more processors, and a non-transitory computer-readable storage medium having a plurality of instructions stored thereon, which, when executed by the one or more processors, cause the one or more processors to perform operations. In some implementations, the operations can include receiving a natural language question for retrieving data stored in the database and interpreting the natural language question to generate a structured query for the database. The structured query can be translated into a natural language representation of the structured query, which can be displayed during execution of the structured query. Responsive data can be received and one or more visualization types for presenting the responsive data to the user can be determined based on the natural language question, the responsive data, and one or more data types of the data. A visualization of the responsive data can be generated based on one visualization type of the determined visualization types, which is displayed in a card in a graphical user interface. The card can include the natural language representation of the structured query and the visualization of the responsive data.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a diagram of an example computing system including an example user computing device, an example server computing device, and an example database according to some implementations of the present disclosure;

FIG. 2 is a functional block diagram of the example user computing device of FIG. 1;

FIG. 3 is a block diagram that illustrates a portion of an example implementation of the techniques of the present disclosure;

FIG. 4 is a diagram of an example graphical user interface according to some implementations of the present disclosure;

FIG. 5 is a diagram of another example graphical user interface according to some implementations of the present disclosure;

FIG. 6 is a diagram of another example graphical user interface according to some implementations of the present disclosure;

FIG. 7 is a diagram of another example graphical user interface according to some implementations of the present disclosure;

FIG. 8 is a diagram of another example graphical user interface according to some implementations of the present disclosure; and

FIG. 9 is a flow diagram of an example technique for utilizing a natural language interface to perform data retrieval and analysis from a database according to some implementations of the present disclosure.

### DETAILED DESCRIPTION

As briefly mentioned above, databases are increasingly being utilized to store more and more data, both in type and in quantity. Additionally, data and data analysis is being utilized to a much greater extent than in the past. Such data analysis is being performed by many individuals that have little to no training in the use, creation, structure, etc. of databases, and thus must rely upon a database “expert” to create and execute queries to the database, e.g., via a query language such as SQL.

The present disclosure is directed to a natural language interface for users to perform data retrieval and analysis on data sets, such as those stored in a database. In some implementations, the present disclosure provides a system and method for receiving a natural language question in the form of a voice input from a user. The voice input is analyzed via speech recognition techniques to determine a textual representation of the voice input. The textual representation of the natural language question is interpreted to generate a structured query for the database, e.g., an SQL query for a relational database, which can then be utilized to retrieve the requested data.

Speech recognition can be somewhat imprecise in that utterances in a voice input may have multiple, valid interpretations that may differ from what is intended by the user. Furthermore, interpretation of a natural language question may also be somewhat imprecise or ambiguous, e.g., due to imprecision in the natural language question itself and/or misinterpretation of the natural language question. Accordingly, the present techniques provide for displaying a natural language representation of the generated structured query. In an example, the generated structured query is translated into the natural language representation, which is presented to the user for validation. One purpose of translating the structured query into the natural language representation is to inform the user how the natural language question was interpreted.

Due to the fact that the generation of the structured query (from the textual representation) and translation of the structured query into the natural language representation can typically be performed more quickly than the structured query can be fully executed, the natural language representation of the structured query is displayed during execution of the structured query. In this manner, the user can do nothing (if the natural language representation matches the user's intended query) and be presented with the results of the structured query as soon as possible. Alternatively, the user can provide an input to correct the natural language question, and thereby stop execution of the structured query, without having to wait until the time consuming process of executing the structured query is complete. In this manner, the user can be presented with the results of the natural language question as efficiently as possible.

Once the structured query has been executed, responsive data can be received for presentation to the user. The responsive data can correspond to many different types of data (raw numerical values, dates, monetary values, unstructured text, structured text, etc.). In many cases, the raw responsive data may not be of much use to the user, and the user may instead prefer a visualization or other organization of the responsive data that is in a more comprehensible form. For example only, if a user provides a natural language question of “daily revenue in the month to date,” it may be more useful for the user to see a bar graph illustrating “daily revenue” than just the raw revenue numbers.

Accordingly, the techniques of the present disclosure provide for determining one or more visualization types for presenting the responsive date to the user. The determination of the one or more visualization types can be based on the natural language question, the responsive data, the one or more data types corresponding to the responsive data, the user, and/or a combination thereof. Each of the one or more visualization types can be an appropriate visualization type for presenting the responsive data based on the data and the one or more data types corresponding thereto. In some implementations, the natural language question itself can be utilized to determine the one or more visualization types. For example only, in the event that the natural language question is “bar graph showing daily revenue in the month to date,” the present techniques can determine that a bar graph is one of the one or more visualization types for presenting the responsive data.

The present techniques further include generating a visualization of the responsive data based on a selected one (a first visualization type) of the determined one or more visualization types. The selection of the visualization type can, e.g., be based on what the techniques determine to be the most appropriate visualization type for the responsive data. As mentioned above, it is possible (and even probable) that many different visualization types are appropriate for displaying the responsive data. In such circumstances, the techniques provide for selecting one of the determined one or more visualization types as a first visualization type to present to the user. The selecting can be based, e.g., on user characteristics, user preferences (either explicit or learned), and/or a set of predetermined rules.

A card that includes the natural language representation of the structured query and the generated visualization can be displayed in a graphical user interface of the user's computing device. In some implementations, the card can also include an interface element (e.g., a button or other toggle element) that switches the visualization of the responsive data to a different visualization type than was originally presented (the selected first visualization type) when selected by the user. In this manner, a user can switch between appropriate visualizations of the responsive data (from the determined one or more visualization types) to obtain a representation of the responsive data that the user feels is most useful/appropriate.

In some implementations, the graphical user interface can include a plurality of cards presented in a dashboard interface, where each of the cards corresponds to a different natural language question. A user can switch between cards (e.g., by selecting a card) in the user dashboard interface to change between natural language queries. Selection of a card can, in some cases, result in re-executing its associated structured query. For example only, if the natural language question is “gross revenue from yesterday,” the re-execution of the associated structured query will return different responsive data depending on the date of execution. In this manner, a user can store one or more cards in the dashboard such that more frequently utilized natural language queries can be repeatedly executed and updated with very little interaction from the user.

In order to provide a more intuitive user experience, the natural language interface of the present disclosure can also utilize the context of a previous natural language question to assist in the interpretation of a natural language question. For example only, a user may provide a first natural language question of “sales revenue in the United States last week” as an input to the natural language interface. After interpreting this query, generating the appropriate structured query, and displaying the visualization of the responsive data to the user, the user may provide a second natural language question of “show as a time series.” The second natural language question (“show as a time series”) may refer to the previous natural language question (“revenue in the United States last week”) and, as it is not a fully formed query, can be interpreted in light of the context of the previous query. Further natural language queries (e.g., “what about unit sales,” “breakdown by product,” “outside of the U.S.”) may also refer to the context(s) of one or more previous queries and, accordingly, can be interpreted based on those context(s).

The present disclosure can include determining whether a received natural language question corresponds to a context of a previous query. For example only, the techniques can provide for determining whether the received natural language question is a fully formed query. A fully formed query may be interpreted independently of the context of the previous query, but interpretation of a non-fully formed query can further be based on the context(s), if appropriate. For a series of related natural language queries, the present disclosure also contemplates the generation of threads or other form of grouping or combination of related cards. In this manner, a user can quickly and effectively interact with related queries by interacting with a thread of related cards. In yet another example, a user can re-run one or more previously executed natural language queries with a change of at least one variable by providing a natural language question that relates to the previously executed natural language queries, similar to a macro and the like.

The disclosed techniques have a number of advantages over previous databases and user interfaces. For example only, the disclosed techniques provide for a more intuitive user interface for data analysis, which may be used effectively by untrained users. Further, the present disclosure describes a more complete data analysis tool that not only returns responsive data to a user, but also provides a more useful format for presenting the data to the user. The techniques also provide for an interactive natural language interface that a user can engage in a “conversation” to more effectively retrieve responsive data from a database. Additional descriptions of various possible implementations of the present disclosure are included below.

The present disclosure is applicable to all types of data and databases. In the following description, certain example natural language questions, data types, and data will be described, specifically with reference to health care data (admittances, patients, billings, International Classification of Disease (“ICD”) services codes, etc.). It should be appreciated that the reference to this type of health care data is merely an example, and other data could be described.

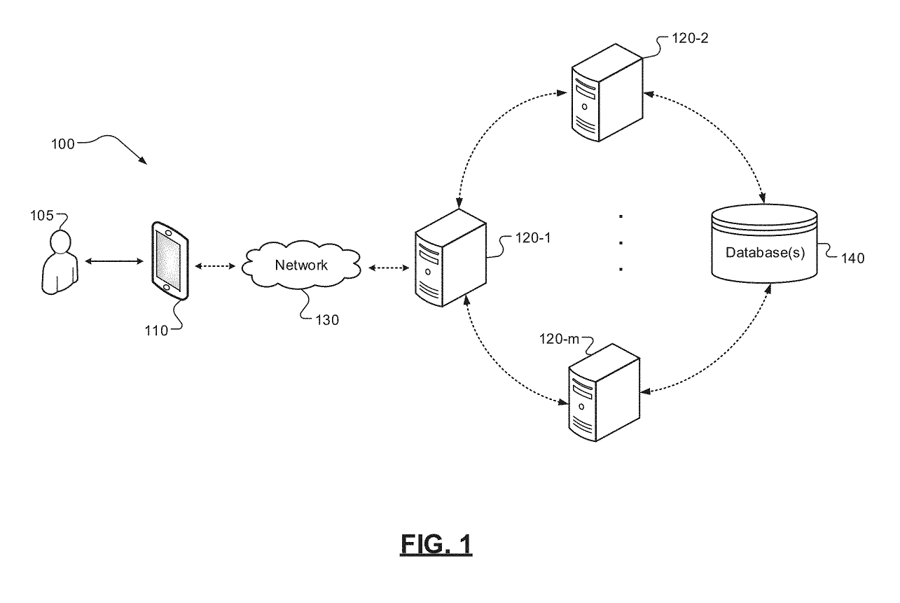

Referring now to FIG. 1, a diagram of an example computing system 100 is illustrated. The computing system 100 can be configured to implement a data retrieval and analysis tool, as described herein. The computing system 100 can include one or more example user computing devices 110 and one or more example server computing devices 120-1, 120-2, . . . 120-m (referred to herein, collectively and individually, as “server computing devices 120”) that communicate via a network 130. The computing system 100 can further include one or more databases 140. The computing system 100 can utilize the server computing devices 120 and the user computing device 110 to implement the data retrieval and analysis tool based on the data stored in the database 140. The database 140 is a collection of data that is organized to be retrievable by the computing devices. The databases 140 can be of any type, including but not limited to a relational database.

For ease of description, in this application and as shown in FIG. 1, a single example user computing device 110 that is associated with a user 105 is illustrated and described. It should be appreciated, however, that many user computing devices 110 can be part of the computing system 110. Further, while FIG. 1 illustrates a plurality of server computing devices 120 in communication with each other, it should also be appreciated that the disclosure is not limited to any specific number of server computing devices 110. The term “server computing device” as used herein is intended to refer to both a single server computing device and multiple server computing devices operating together, e.g., in a parallel or distributed architecture.

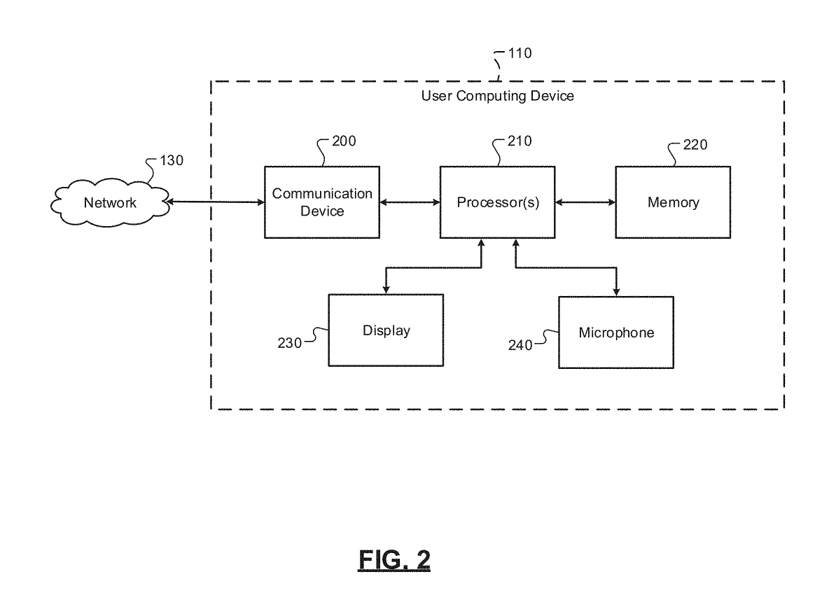

The example user computing device 110 is illustrated in FIG.1 as a mobile phone (“smart” phone), however, the user computing device 110 can be any type of suitable computing device, such as a desktop computer, a tablet computer, a laptop computer, a wearable computing device such as eyewear, a watch or other piece of jewelry, or clothing that incorporates a computing device. A functional block diagram of an example user computing device 110 is illustrated in FIG. 2.

The computing device 110 can include a communication device 200, one more processors 210, a memory 220, a display device 230, and a microphone 240. The processor(s) 210 can control operation of the computing device 110, including implementing at least a portion of the techniques of the present disclosure. The term “processor” as used herein is intended to refer to both a single processor and multiple processors operating together, e.g., in a parallel or distributed architecture.

The communication device 200 can be configured for communication with other devices (e.g., the server computing device(s) 120) via the network 130. One non-limiting example of the communication device 200 is a transceiver, although other forms of hardware are within the scope of the present disclosure. The memory 220 can be any suitable storage medium (flash, hard disk, etc.) configured to store information. For example, the memory 220 may store a set of instructions that are executable by the processor 210, which cause the computing device 110 to perform operations, e.g., such as the operations of the present disclosure. In some implementations, the memory 220 can include/implement a database (such as database 140).

The display device 230 can display information to the user 105. In some implementations, the display device 230 can comprise a touch-sensitive display device (such as a capacitive touchscreen and the like), although non-touch display devices are within the scope of the present disclosure. The microphone 240 can be utilized to capture audio signals, such as a user voice input or utterance, for further processing, e.g., by the user computing device 110.

It should be appreciated that the example server computing devices 120 can include many of the same or similar components as the user computing device 110, and thus can be configured to perform some or all of the techniques of the present disclosure. Further, these techniques can be performed wholly by one computing device, or be split into separate tasks that can be distributed and performed by multiple computing devices.

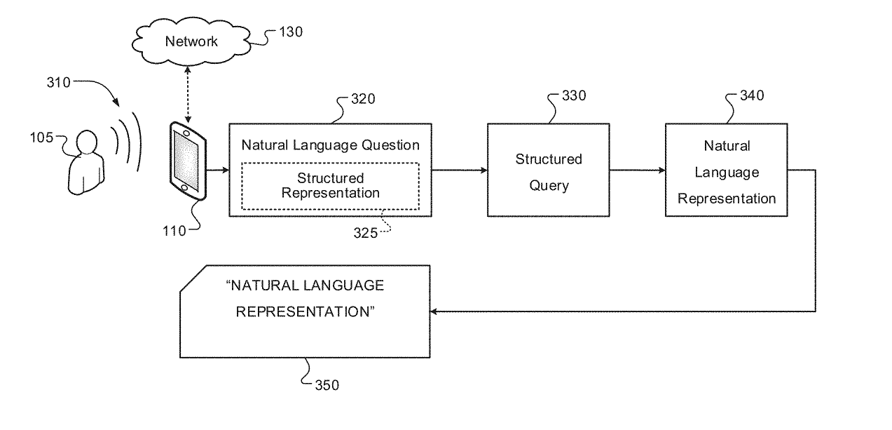

A block diagram that illustrates a portion of an example implementation of the techniques of the present disclosure is shown in FIG. 3. In this example, a user 105 provides a voice input 310 to her/his associated user computing device 110. The voice input 310 is an attempt by the user 105 to express, in the natural language of the user 105, a request for data stored in the database 140. The user computing device 110 receives this voice input 310 and utilizes a speech recognition process to determine a textual representation of the voice input 310.

The textual representation of the voice input 310 can comprise a natural language question 320 that is utilized to retrieve responsive data stored in the database 140. In this example, the speech recognition process is described as occurring at the user computing device 110. It should be appreciated, however, that the speech recognition process can occur at the user computing device 110, at one or more of the server computing devices 120, or a combination thereof. Furthermore, in some implementations, the user 105 can provide the natural language question 320 directly to the user computing device 110, e.g., via a textual or other non-voice user input that does not require speech recognition.

As briefly mentioned above, the natural language question 320 corresponds to an attempt by the user 105 to formulate a request for responsive data that is stored in the database 140. The database 140 may store data in a structured manner that can be retrieved through interaction with a database management system (“DBMS”). The DBMS may define the manner in which the database 140 is structured, as well as the manner in which one can store, retrieve, analyze, etc. data in the database 140. For ease of description, the present disclosure will utilize the term “database” to describe the database 140, the DBMS, and combination thereof. It should be appreciated, however, that the DBMS may be implemented separately from the formal database 140, e.g., by one or more server computing devices 120.

In order to retrieve data from the database 140, a structured query 330 (such as in SQL) may be required. A structured query 330 corresponds to a query that is properly formatted, arranged, etc. and contains the proper syntax to communicate with a database 140. As mentioned above, a user 105 may require training to compose a proper structured query 330. The present techniques, however, provide for interpreting the natural language question 320 provided by the user 150 to generate a structured query 330 that is sufficient to retrieve the responsive data from the database 140. The natural language question 320 can be interpreted by the user computing device 110, the server computing device 120, or a combination thereof.

Databases 140 may categorize data by providing each category of data with a unique label in the database 140 such that the category may be uniquely identified for retrieval, storage, etc. via a structured query 330. In some cases, the database 140 can be conceptualized as a table structure with categories of the database 140 described as “columns” and records or entries described as “rows.” For example only, in a database 140 in which health care data is recorded, the database 140 may include data for each patient (e.g., in a row) that corresponds to different data categories (e.g., in columns), such as an admittance date, a release date, an International Classification of Disease (“ICD”) service code, and others. In the database 140 itself, the “admittance date” may be provided with the unique label of “@_AdmDate,” the “release date” may be provided with the unique label of “@_RelDate,” and so on. To generate the appropriate structured query 330 to retrieve data corresponding to sales with a specific order date, a user 105 must know not only the syntax, commands, etc. of the appropriate language for a structured query, but also the appropriate labels corresponding to the variable(s) of interest (e.g., “admittance date” is labeled “@_AdmDate,”).

The natural language question 320 to structured query 330 interpretation can be performed in different ways. The natural language question 320 can be parsed to determine individual words, phrases, sentences, etc., which will be referred to herein as “utterances.” In some aspects, a structured representation 325 can be generated from the natural language question 320, e.g., based on the utterances. A structured representation 325 can comprise a fully formed question that specifies the variables, data, and/or other information that the user 105 is attempting to obtain with the natural language question 320. As described more fully below, there may be more than one possible interpretation of the natural language question 320, e.g., due to ambiguity present in the natural language question 320 and/or the failure of the natural language question 320 to fully specify variables. The structured representation 325 is an attempt by the user computing device 110 (and/or server computing device(s) 120) to fully specify the intent of the user 105 from the natural language question 320.

In some aspects, the structured representation 325 can include a spell checked and corrected version of the natural language question 320. For example only, if the received natural language question 320 is “daily revenu” the user computing device 110 (and/or server computing device(s) 120) can correct the misspelling of “revenu” to “revenue.” Any of the known spell checking/correction algorithms can be utilized, so further details of such will not be provided. Additionally or alternatively, a knowledge base can be utilized to identify entities within the natural language question 320. An “entity” can be any person, place, or thing (noun), and examples of entities include, but are not limited to, people, items, places or locations, data categories, types of data, dimensions, metrics, and date ranges. The creation and use of such knowledge bases are known and, e.g., are utilized with a search engine to identify entities or concepts related to text (as opposed to merely searching for keyword terms). As an example, a knowledge base can be utilized to assist in identifying that “may” may represent the month of May (as opposed to the verb “may”).

In yet another example, the structured representation 325 can be generated from the natural language question 320 by selecting “default” values for variables that are ambiguous or left unspecified by the user 105. For the natural language query 320 of “daily admittances,” the date range (time period) over which the user 105 is requesting such “daily admittances” is left unspecified. The user computing device 110 (and/or the server computing device(s) 120) can generate the structured representation 325 by providing a default time period of a day, week, month, or any other reasonable value.

The selection of the default value can be based on one or more factors, such as the user computing device 110, the visualization type to be generated, and/or the attributes of the requesting user 105. For example only, the size of the display of the user computing device 110 upon which the resulting data/visualization will be displayed may be utilized to determine the appropriate amount of data (time period) to retrieve. In another example, for a user 105 in a sales role, a natural language question 320 of “what are the top countries” may be assigned a default metric of “revenue” since this metric may be presumed to match the intent of the user 105. The assignment of defaults values can be performed based on a set of assignment rules, e.g., that are manually generated by the database creator and/or set by the user 105.

The utterances in the natural language question 320/structured representation 325 can then be matched to data, categories of data, visualization types, and/or other words representative of the intent of the user 105. For example only, a user 105 may provide a natural language question 320 of “top” that the natural language interface will recognize as a request for a sort order. In another example, an utterance of “trend” may be interpreted as a time series query. As described more fully below, the natural language interface may be designed such that each category of data, visualization types, user intent words, and the data itself may be assigned one or more utterances. When the natural language question 320 is parsed into its utterances, the user computing device 110 can then “match” the utterances of the natural language question 320 to the appropriate categories, visualization types, and/or data in the database 140.

For example only, and continuing with the example above, the unique label of “@_AdmDate” may be assigned the utterances “admittance date,” “admit date,” “date of admittance,” “date of admit,” “admitted on” etc. Thus, when a user 105 provides a natural language question 320 of “patients admitted on [X],” the user computing device 110 will interpret this query to be equivalent to a structured query of products “where (@_Adm Date=[X]).” A similar technique can be performed for data.

The assignment of utterances to data and categories of data can be accomplished in different ways. The assignment may be performed by manual annotation, e.g., at the time of creation of the database 140. Additionally or alternatively, the assignment may be performed by an automated process in which relationships between entities and synonyms are determined for utterances, e.g., via machine learning or similar process. For example only, an initial assignment of “admittance date” to “@_AdmDate” can be manually annotated, and an automated process can then be used to determine the relationship of “admit date,” “date of admittance,” “date of admit,” “admitted on” etc. as likely synonyms for “admittance date” such that these additional utterances can also be assigned to “@_AdmDate.”

In some implementations, the interpretation of the natural language question 320 to generate the structured query 330 can be based on the attributes of the user 105, such as his/her role, position, and/or association with the database 140. For example only, the attributes of the user 105 may assist in determining the responsive data in which the user 105 is interested and, thus, the proper structured query 330 to retrieve that responsive data.

For example only, if the user 105 provides a natural language question 320 of “my patients to date,” the user computing device 110 may determine that natural language question 320 be interpreted to generate a structured query 330 to retrieve data related to the sales for that particular user 105. In another example, if the user 105 provides a natural language question 320 of “my monthly production to date,” the user computing device 110 may determine that the word “production” should be interpreted based on the role of the user 105 with respect to the data. If the user 105 is in a surgical role, the user computing device 110 may interpret “production” to be “number of surgeries” or similar. If, however, the user 105 is in a finance role, the user computing device 110 may interpret “production” to be “revenue” or the like.

In yet another example, if the user 105 has restricted access to the database 140, such as through an access control list or other mechanism that provides only limited data to the user 105, the user computing device 110 may utilize the user's 105 access rights to interpret the natural language question 320. Because the interpretation of the natural language question 320 is basically an attempt to determine the responsive data that the user 105 intended to retrieve, the user computing device 110 may generate the structured query 330 to retrieve data to which the user 105 has access rights.

It is likely that there will be more than one possible interpretation of the natural language question 320, e.g., due to ambiguity present in the natural language question 320, misinterpretation, and/or failure to provide a complete and fully formed query by the user 105. In this event, the user computing device 110 may select one interpretation as the structured query 330 (e.g., the one that has the highest likelihood of corresponding to the natural language question 320) for execution.

In some aspects, the natural language interface may be unable to generate a single appropriate structured query 330 based on the natural language question 320. For example only, a user 105 may submit a natural language question 320 of “daily admittances in Apr. 2010.” The natural language interface may be able to generate a structured representation 325 of this natural language question 320 but not a structured query 330 because the data was not stored on a daily basis as requested.

In yet another example, a user 105 may submit a natural language question 320 that requests two or more different sets of data/data types, such as “daily admittances and procedures in April.” In this example, the natural language interface may be able to generate a structured representation 325 of this natural language question 320 but not a single structured query 330. In such cases, in some implementations two or more structured queries 330 may be generated based on a single natural language question 320.

The selected structured query 330, however, may not correspond to what the user 105 intended by the natural language question 320 and, thus, can be perceived as an error. Execution of the selected structured query 330 and presentation of the responsive data to the user 105 may not necessarily indicate to the user 105 that such an error was made, which may lead the user 105 to receive—and not detect—incorrect responsive data. In order to address this issue, the present techniques provide for the presentation of the interpretation of the natural language question 320 to the user 105 for confirmation of her/his intent. Because the user 105 is most likely unfamiliar with, and/or unable to comprehend, structured queries, presenting the selected structured query 330 to the user 105 for confirmation of her/his intent would not be beneficial. Accordingly, the present techniques provide for translating the structured query 330 into a natural language representation 340 of the structured query 330, which can be displayed to the user 105 as a form of confirmation of the intent of the user's natural language question 320.

Translation of the structured query 330 into a natural language representation 340 of the structured query 330 can be performed in many ways. In some implementations, the user computing device 110 can store a plurality of translation rules that can be utilized. The translation rules can be, e.g., manually annotated and/or generated by an automated process, such as a translation model, to provide an unambiguous expression of any structured query 330 into the natural language of the user 105. For example only, a natural language question 320 of “I want the monthly admittances” is interpreted to generate a structured query 330, which can then be translated into the natural language representation 340 of “Patients per day for April 2016” or similar.

As briefly mentioned above, the natural language representation 340 can be displayed in a card 350 in the user interface of the user computing device 110. The generation of the natural language representation 340 from the structured query 330 typically will be performed more quickly than execution of the structured query 330 and retrieval of the associated responsive data. Accordingly, the present techniques contemplate displaying the natural language representation 340 to the user 105 during execution of the structured query 330. The concurrent execution of the structured query 330 and displaying of the natural language representation 340 to the user 105 can provide for a more efficient use of time and quicker presentation of the responsive data to the user 105. Furthermore, if the natural language representation 340 is perceived to be incorrect, the user 105 may be able to stop execution of the structured query 330 before it is completed, thus allowing for refinement of the natural language question 320.

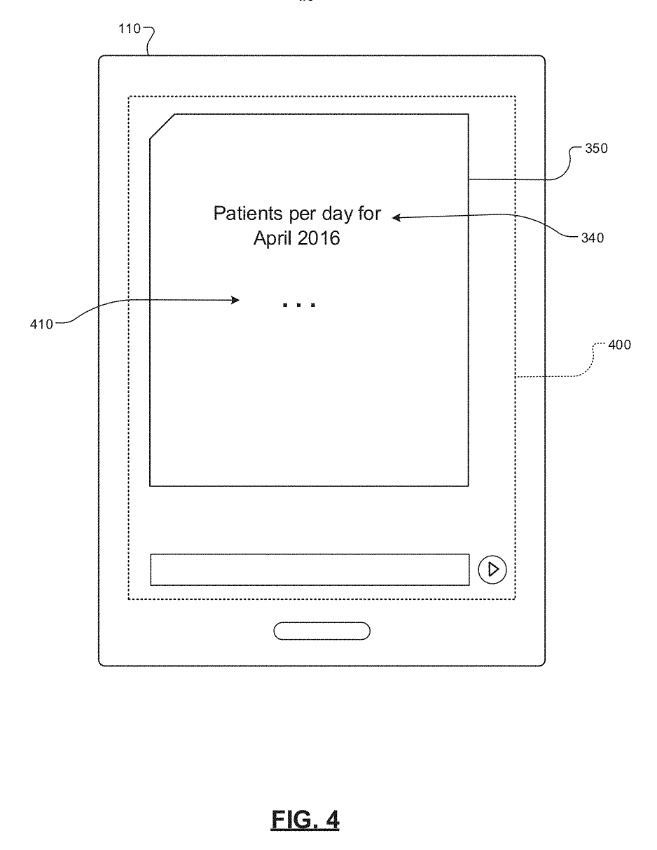

Referring now to FIG. 4, an example GUI 400 that can be displayed by the display device 230 of the example user computing device 110 according to certain implementations of the present disclosure is shown. The GUI 400 can include the card 350 that includes the natural language representation 340 of the structured query 330, as described above. Further, an indicator 410 can be included to illustrate that user computing device 110 is currently executing the structured query 330. In the illustrated example, the indicator 410 comprises an ellipsis (“ . . . ”), although other forms of the indicator 410 are within the scope of the present disclosure.

The user computing device 110 can receive responsive data from the database 140 in response to the structured query 330. The responsive data can correspond to one or more data types, as mentioned above. The user computing device 110 can also determine one or more visualization types for presenting the responsive data to the user 105. The determination of the one or more visualization types can be based on one or more factors, such as the natural language question 320, the responsive data, the one or more data types, and any combination thereof.

In some implementations, the natural language question 320 can specify what type of visualization the user 105 desires to receive. For example only, a user 105 may provide a natural language question 320 that includes “show me a bar graph of . . . ” as an input to the user computing device 110. In such a case, the user computing device 110 can determine the one or more visualization types to include a bar graph as requested. In yet another example, if the natural language question 320 includes “show me a trend of . . . ” it may be determined that a time based visualization (such as a time series) is an appropriate visualization type to display to the user 105.

The responsive data 320 can additionally or alternatively provide a signal as to an appropriate visualization type to display to the user 105. For example only, if the responsive data includes percentages that are representative of a whole, it may be determined that a pie chart or similar visualization type is appropriate. The one or more data types represented by the responsive data can be utilized as a signal. If the responsive data includes a data type representing a date, it may be determined that a date based visualization (bar graph, time series, etc.) is appropriate to display the responsive data.

In some implementations, the determination of the one or more visualization types can further be based on the user 105. The attributes of the user 105, such as his/her role, position, and/or association with the database 140, may assist in determining the proper form for presenting the responsive data to the user 105. For example only, if the user 105 provides a natural language question 320 of “monthly procedures to date,” the user computing device 110 may determine that the one or more visualization types include a time based visualization (a bar graph, time series, etc.) if the user 105 is in a surgical role. Alternatively, if the user 105 is in a management role, the user computing device 110 may determine that a proportional visualization (such as a pie chart that breaks down monthly sales by division, group, etc.) be included in the one or more visualization types.

It should be appreciated that the user computing device 110 may determine that there are many appropriate visualization types available to display the responsive data, even in the situation where a user 105 specifically requests a visualization type (“show me a bar graph . . . ”) in the natural language question 320. In such an event, the user computing device 110 can select one visualization type of the determined one or more visualization types (e.g., the one that has the highest likelihood of corresponding to the intent of the user 105) to generate a visualization of the responsive data.

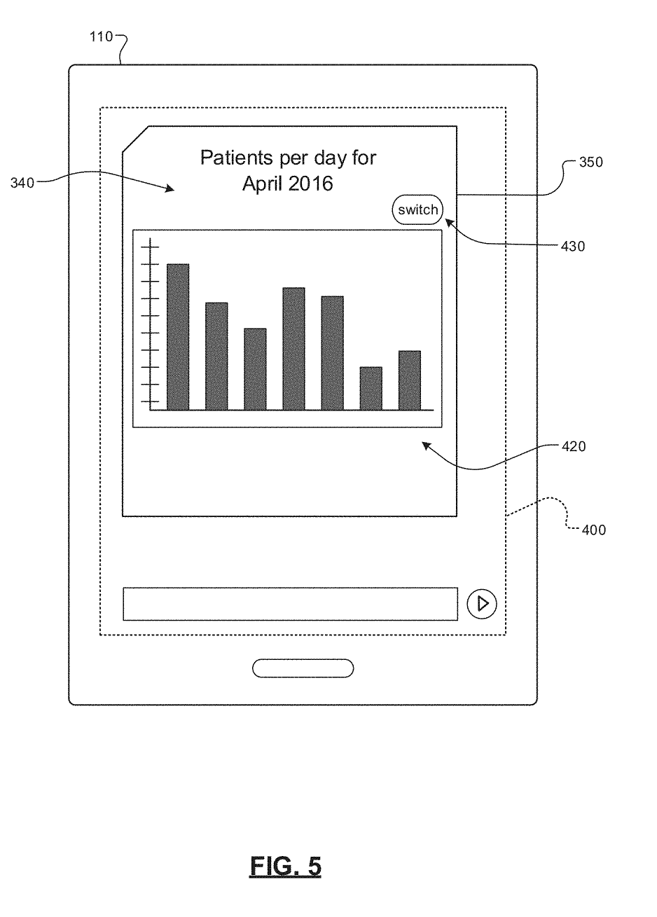

With additional reference to FIG. 5, the computing device 110 can generate a visualization 420 of the responsive data based on the selected visualization type (a “first visualization type”) of the one or more visualization types determined to be appropriate. The visualization 420 can be included on the card 350, which is displayed in the GUI 400 on the display device 230 of the user computing device 110. The card 350 can also include the natural language representation 340 of the structured query 330 and, in some implementations, an interface element 430. The interface element 430 can be selected by the user 105 to switch the visualization 420 to a different one of the determined one or more visualization types, as described more fully below.

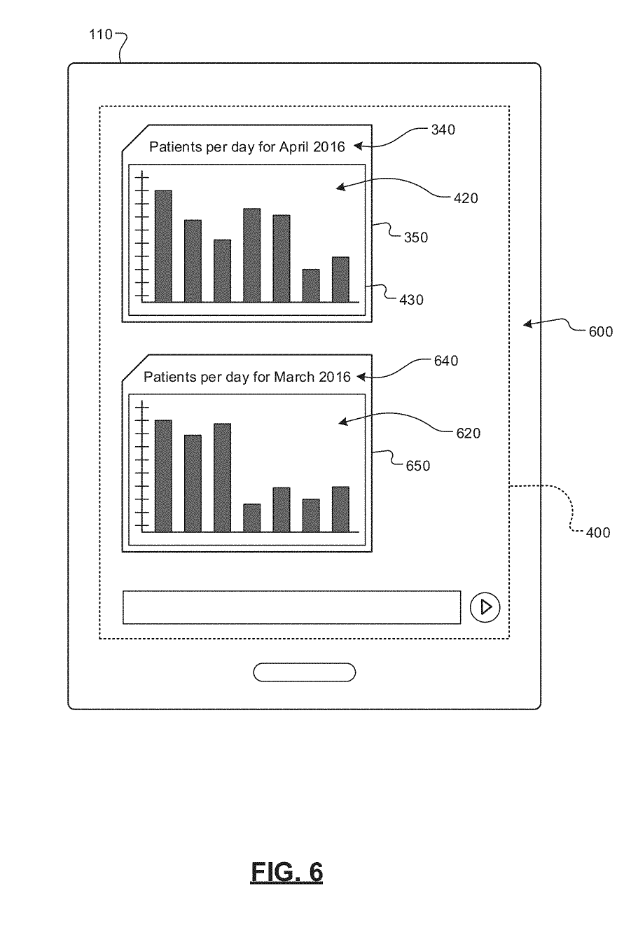

In some implementations, the GUI 400 can further display a dashboard 600, an example of which is shown in FIG. 6, for the data retrieval and analysis tool of the present disclosure. The dashboard 600 can provide for an intuitive and simple interface for the user 105 to interact with the data retrieval and analysis tool. The dashboard 600 can store and display one or more cards 350, 650 related to natural language queries 320 provided by the user 105. In this manner, a user 105 can maintain a record of previously executed natural language queries 320. The dashboard 600 can be automatically created upon generation of a card 350, 650 or, alternatively, be created upon request of the user 105, e.g., by selecting a graphical element (star, pin, etc.) on the card 350, 650. Further, in some implementations, the user 105 can select a card 350, 650 to re-execute its associated structured query 330. For example only, if a user 105 desires to retrieve responsive data to the same natural language question 320 of “monthly admittances to date,” the user 105 can select the card 350 associated with that natural language question 320 and receive up-to-date responsive data. In this manner, the dashboard 600 can provide a customized experience for the user 105 without requiring the user 105 to repeatedly enter a natural language question 320.

In the example shown in FIG. 6, the card 350 can be associated with the natural language question 320 “I want the monthly admittances,” which has been interpreted and translated into the natural language representation 340 of “Patients per day for April 2016” as shown. Furthermore, another card 650 is shown, which may be associated with another natural language question of “admittances from the previous month” or similar. Similarly, this other natural language question of “admittances from the previous month” has been interpreted and translated into the natural language representation 640 of “Patients per day for March 2016” as shown. A visualization 620 of the responsive data retrieved in response to the other natural language question (“Patients from the previous month”) is displayed in the card 650.

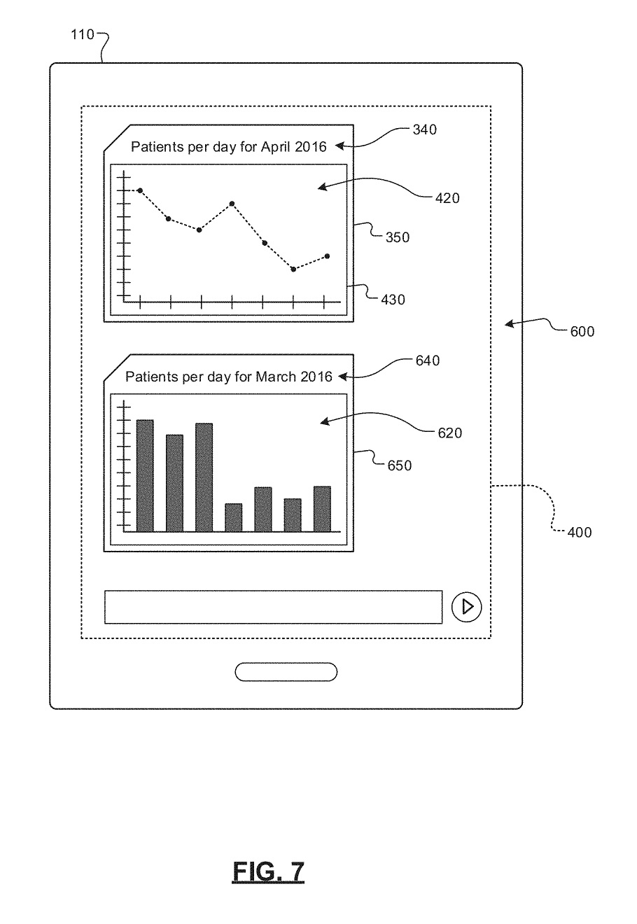

As mentioned above, the card 350 can also include the natural language representation 340 of the structured query 330 and, in some implementations, an interface element 430. In the illustrated example of FIG. 6, the interface element 430 comprises the visualization 420, which can be selected by the user 105 to switch the visualization 420 to a different one of the determined one or more visualization types. In this implementation, the user 105 can select the interface element 430 by clicking, hovering over, etc. the visualization 420 to change the visualization type of the responsive data. An example of the switching of the visualization 420 is shown in FIG. 7, where the previously shown bar graph (FIG. 6) has switched to a time series representation. The interface element 430 provides the user 105 with the ability to quickly and easily switch the visualization 420 of the responsive data between different types of the determined one or more visualization types.

The present disclosure further provides the user 105 with the ability to build related queries and/or “drill down” into previously retrieved responsive data in a simple, intuitive manner. Specifically, the present techniques permit the user 105 to create a thread of natural language queries that are related by context, and to further display the responsive data in the GUI 400 in such a way as to convey to the user 105 the relationship between the queries.

In some implementations, when a natural language question 320 is received, the user computing device 110 can determine whether the natural language question 320 corresponds to a context of a previous natural language question. In one non-limiting example, the user computing device 110 can determine whether the natural language question 320 corresponds to a context of a previous natural language question by determining with the natural language question 320 is a fully formed query.

A fully formed query can be, e.g., a query that does not—explicitly or implicitly—refer to a previous query and/or otherwise “stands alone” and can be interpreted in at least one unambiguous manner by itself. For example only, a natural language question 320 of “I want the monthly admittances” can be determined to be a fully formed query in that the user computing device 110 can determine the associated structured query 330 without reference to a previous query. A natural language question of “same analysis for the previous month,” however, can be determined to not be fully formed in that it explicitly (“same analysis”) refers to previous natural language question 320. In yet another example, a natural language question of “what about the previous month” can be determined to not be fully formed in that it implicitly refers to a previous natural language question 320.

In the event it is determined that the natural language question 320 corresponds to the context of one or more previous queries, the interpretation of the natural language question 320 can further be based on the context of the of one or more previous queries. Thus, to continue with one of the examples above, the natural language question of “same analysis for the previous month” can be interpreted by the user computing device 110 to mean “perform the same analysis as was just performed for the previous month” or similar.

In some implementations, the context of the previous query can correspond to the responsive data received in response to the previous query. For example only, if a previously received natural language question 320 of “I want the monthly admittances” was received, followed by another natural language question of “just for the surgical department,” the user computing device 110 can limit the responsive data to the other natural language question (“just for the United States”) to a subset of the responsive data corresponding to the previously received natural language question 320 (“I want the monthly admittances”).

In additional or alternative implementations, the context of one or more previous natural language queries can be utilized to interpret a natural language question 320 that is intended to re-run the previously executed one or more previous natural language queries with a change of at least one variable. For example only, if the previously received natural language queries of “I want the monthly admittances” followed by “just for the surgical department” were received by the user computing device 110, a subsequent natural language question 320 of “now do it for the emergency department” can be analyzed based on the context of those previous queries. The interpretation of the natural language question 320 “now do it for the emergency department” can be determined by the user computing device 110 to re-run the previously executed “I want the monthly admittances” query with the variable of “the surgical department” changed to “the emergency department” as specified. In this manner, a user 105 can create macros that can be referred to and re-executed.

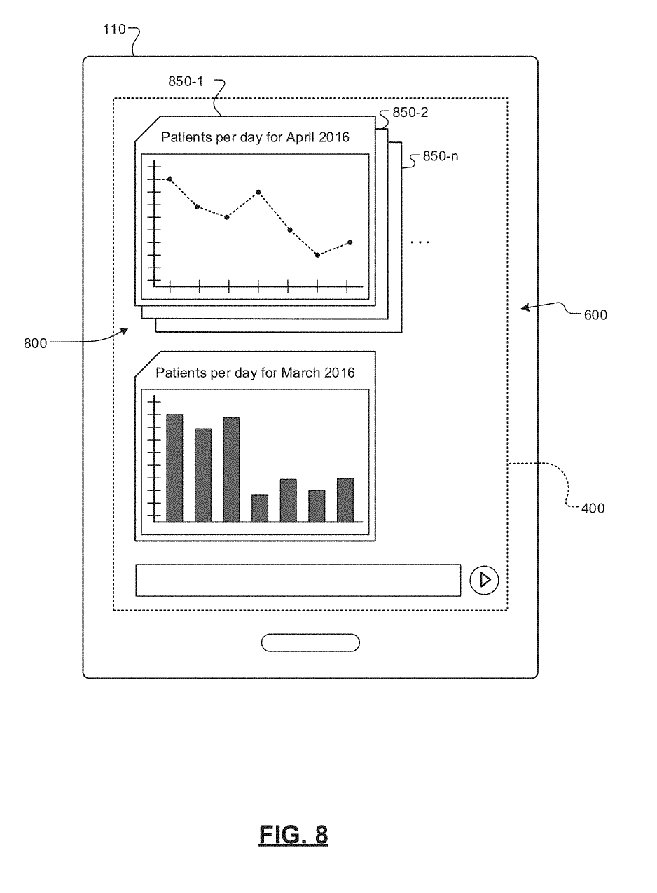

As briefly mentioned above, and with further reference to FIG. 8, the user computing device 110 can display cards that are related by context in a thread 800. A thread 800 can include a plurality of cards 850-1, 850-2, . . . 850-n (referred to herein individually and collectively as “card(s) 850”). The user 105 can select each card 850 in the thread 800. In some implementations, selection of a card 850 by the user 105 will select the context of that card 850 such that a later received natural language question received will be interpreted in light of the context of the selected card. In this manner, a user 105 can quickly and effectively interact with related queries by interacting with a thread 800 of related cards 850, as well as add additional natural language queries 320 to the thread 800, if desired. Further, with respect to a natural language question 320 that is intended to re-run a previously executed query for a different data set/variable (a “macro” as described above), such macros can be displayed in a thread 800 of the previously received natural language queries or a new thread can be created.

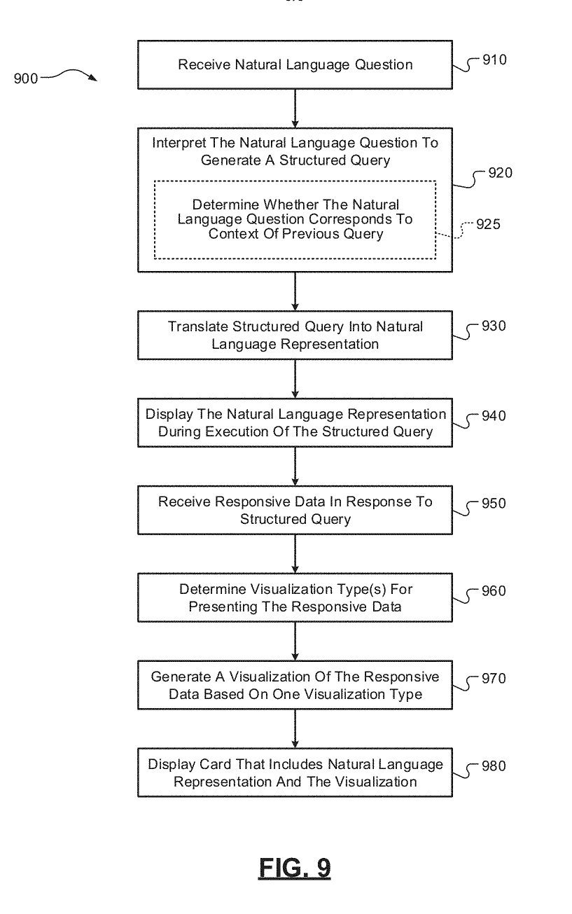

A flow diagram of an example technique 900 for utilizing a natural language interface to perform data retrieval and analysis according to some implementations of the present disclosure is illustrated in FIG. 9. While the technique 900 will be described below as being performed by the user computing device 110, it should be appreciated that the technique 900 can be performed, in whole or in part, at the server computing device(s) 120 described above, and/or at more than one user computing device 110.

At 910, a natural language question 320 is received at the user computing device 110. The natural language question 320 can be composed by the user 105 as an attempt to retrieve data stored in a database, such as database(s) 140 described above. The user computing device 110, at 920, can interpret the natural language question 320 to generate a structured query 330 for the database(s) 140. In some implementations, and as described more fully above, the interpretation of the natural language question 320 to generate a structured query 330 can include (at 925) determining whether the natural language question 320 corresponds to a context a previously received/executed query. When the natural language question 320 corresponds to the context a previous query, the interpretation of the natural language question 320 can further be based on that context.

The user computing device 110 can translate the structured query 330 into a natural language representation 340 of the structured query 330 at 930. At 940, the user computing device 110 can display the natural language representation 340 while also executing the structured query 330. In this manner, and as described above, the user 105 can both confirm that the user computing device 110 has appropriately interpreted the natural language question 320 while also provide responsive data to the user 105 without unnecessary delay.

The user computing device 110 can receive (at 950) responsive data in response to the structured query 330. The responsive data can correspond to one or more data types. The data type(s) can, as described herein, be utilized to determine one or visualization types for presenting the responsive data to the user 105. More specifically, the user computing device 110 can determine one or more appropriate visualization types for presenting the responsive data to the user 105 at 960. The determination (960) of the visualization type(s) can be, e.g., based on the natural language question 320, the responsive data, and/or the one or more data types.

At 970, the user computing device 110 can generate a visualization 420 based on one (a “first visualization type”) of the determined visualization type(s). The user computing device 110 can also (at 980) display a card (such as card 350, 650, or 850) (a “first card”) in a GUI (such as GUI 400) on its display device 230. The first card can include the natural language representation 340 of the structured query 330 and the visualization 420 of the responsive data.

The natural language interface of the present disclosure can also be adapted, e.g., based on implicit or explicit user feedback, to improve its quality and performance. As mentioned above, the interpretation of a natural language question 320 is performed to generate a structured query 330 that retrieves the responsive data that the user 105 intended to receive. Thus, feedback from the user 105 can be received and utilized, e.g., to assist in the assignment of utterances to data and categories of data, as mentioned above. For example only, explicit user feedback can be obtained and utilized to improve the natural language interface.

In some implementations, the natural language interface can be improved by identifying words that were not “matched” to data, a category of data, visualization type or other word representing the intent of the user 105. The part of speech for each of these identified words can also be determined. The identified words can also be compared to a knowledge base that can identify the entity or entities to which the word relates, and/or identify similar words, concepts, etc. to which the identified words relate. A clustering or other grouping of these identified words can be performed to simplify the analysis and/or more easily identify issues. In this manner, the natural language interface can identify areas for improvement in the interpretation of natural language queries. It should be appreciated that other forms of adaption can be utilized to improve the performance of the natural language interface.

While the technique 900 and other specific implementations above are primarily described as being performed by the user computing device 110, it should be appreciated that any of these implementations, or portions thereof, can be performed, in whole or in part, at the user computing device 110, the server computing device(s) 120, and/or a combination thereof. The techniques of the present disclosure specifically contemplate that the execution of various portions of the techniques will be distributed amongst a plurality of computing devices. For example only, in some implementations, the user computing device 110 will receive a voice input 310 from the user 105, the speech recognition process will be performed by a first server computing device 120, which will pass natural language question 320 to another serving computing device 120 for interpretation, and so on.

The present disclosure contemplates that the natural language question 320 may not merely be a request for data retrieval, but can also include a command to perform a certain action based on data in the database 140. In some aspects, the natural language interface can be utilized to notify a user 105 when the data in the database 140 satisfies a condition. For example only, a user 105 can provide a natural language question 320 of “let me know when monthly admittances exceeds [X]” or similar. The natural language interface can generate the structured query 300, which can be executed periodically to determine whether the monthly admittances exceeds [X] as requested. When the condition is met (monthly admittances exceeds [X]), the user 105 can be notified, e.g., via the GUI 400, an email, and/or a text or other instant message. In this manner, the natural language interface can determine which of these visualization types is appropriate for the natural language question 320 (as described above), which can be displayed to the user 105.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the term module may refer to, be part of, or include: an Application Specific Integrated Circuit (ASIC); an electronic circuit; a combinational logic circuit; a field programmable gate array (FPGA); a processor or a distributed network of processors (shared, dedicated, or grouped) and storage in networked clusters or datacenters that executes code or a process; other suitable components that provide the described functionality; or a combination of some or all of the above, such as in a system-on-chip. The term module may also include memory (shared, dedicated, or grouped) that stores code executed by the one or more processors.

The term code, as used above, may include software, firmware, byte-code and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein, and any references to specific languages are provided for disclosure of enablement and best mode of the present invention.

The present disclosure is well suited to a wide variety of computer network systems over numerous topologies. Within this field, the configuration and management of large networks comprise storage devices and computers that are communicatively coupled to dissimilar computers and storage devices over a network, such as the Internet.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method, comprising:
receiving, at a computing device having one or more processors and from a user, a natural language question for retrieving data stored in a database;
interpreting, at the computing device, the natural language question to generate a structured query for the database;
translating, at the computing device, the structured query into a natural language representation of the structured query;
displaying, on a display of the computing device, the natural language representation of the structured query during execution of the structured query;
receiving, at the computing device, responsive data in response to the structured query, the responsive data corresponding to one or more data types;
determining, at the computing device, one or more visualization types for presenting the responsive data to the user based on the natural language question, the responsive data, and the one or more data types;
generating, at the computing device, a visualization of the responsive data based on a first visualization type of the determined one or more visualization types; and
displaying, in a graphical user interface on the display of the computing device, a first card that includes the natural language representation of the structured query and the visualization of the responsive data.

2. The computer-implemented method of claim 1, wherein the first card includes an interface element that, when selected by the user, switches the visualization of the responsive data to a second visualization type of the one or more visualization types.

3. The computer-implemented method of claim 2, wherein the interface element comprises the first visualization.

4. The computer-implemented method of claim 1, further comprising determining, at the computing device, whether the natural language question corresponds to a context of a previous query, wherein, when the natural language question corresponds to the context of the previous query, the interpreting the natural language question to generate the structured query is based on the context of the previous query.

5. The computer-implemented method of claim 4, wherein, when the natural language question corresponds to the context of the previous query, the first card is displayed in a thread corresponding to the previous query.

6. The computer-implemented method of claim 4, wherein the context of the previous query corresponds to previously received responsive data to the previous query, and the responsive data in response to the structured query comprises a subset of the previously received responsive data.

7. The computer-implemented method of claim 4, wherein determining whether the natural language question corresponds to the context of the previous query comprises determining whether the natural language question is a fully formed query.

8. The computer-implemented method of claim 1, further comprising:
storing, at the computing device, the first card in a dashboard in the graphical user interface of the computing device; and
re-executing, at the computing device, the structured query when the user selects the first card.

9. The computer-implemented method of claim 1, wherein the interpreting the natural language question to generate the structured query is based on one or more attributes of the user.

10. The computer-implemented method of claim 1, wherein the determining the one or more visualization types for presenting the responsive data to the user is further based on the user.

11. A computing device, comprising:
a display;
one or more processors; and
a non-transitory computer-readable storage medium having a plurality of instructions stored thereon, which, when executed by the one or more processors, cause the one or more processors to perform operations comprising:
receiving, from a user, a natural language question for retrieving data stored in a database;
interpreting the natural language question to generate a structured query for the database;
translating the structured query into a natural language representation of the structured query;
displaying, on the display, the natural language representation of the structured query during execution of the structured query;
receiving responsive data in response to the structured query, the responsive data corresponding to one or more data types;
determining one or more visualization types for presenting the responsive data to the user based on the natural language question, the responsive data, and the one or more data types;
generating a visualization of the responsive data based on a first visualization type of the determined one or more visualization types; and
displaying, in a graphical user interface on the display, a first card that includes the natural language representation of the structured query and the visualization of the responsive data.

12. The computing device of claim 11, wherein the first card includes an interface element that, when selected by the user, switches the visualization of the responsive data to a second visualization type of the one or more visualization types.

13. The computing device of claim 12, wherein the interface element comprises the first visualization.

14. The computing device of claim 11, wherein the operations further comprise determining whether the natural language question corresponds to a context of a previous query, wherein, when the natural language question corresponds to the context of the previous query, the interpreting the natural language question to generate the structured query is based on the context of the previous query.

15. The computing device of claim 14, wherein, when the natural language question corresponds to the context of the previous query, the first card is displayed in a thread corresponding to the previous query.

16. The computing device of claim 14, wherein the context of the previous query corresponds to previously received responsive data to the previous query, and the responsive data in response to the structured query comprises a subset of the previously received responsive data.

17. The computing device of claim 14, wherein determining whether the natural language question corresponds to the context of the previous query comprises determining whether the natural language question is a fully formed query.

18. The computing device of claim 11, wherein the operations further comprise:
storing the first card in a dashboard in the graphical user interface of the computing device; and
re-executing the structured query when the user selects the first card.

19. The computing device of claim 11, wherein the interpreting the natural language question to generate the structured query is based on one or more attributes of the user.

20. The computing device of claim 11, wherein the determining the one or more visualization types for presenting the responsive data to the user is further based on the user.
